(19) United States
(12) Patent Application Publication
(10) Pub. No.: US 2016/0329721 A1
(43) Pub. Date: Nov. 10, 2016

(54) ZERO EXPORT RELAY

(71) Applicant: GNG ELECTRICAL PTY LTD, Tweed Heads , New South Wales (AU)

(72) Inventor: Gregory Neville ROGERS, Tweed Heads (AU)

(73) Assignee: GNG ELECTRICAL PTY LTD, Tweed Heads, New South Wales (AU)

(21) Appl. No.: 15/111,351

(22) PCT Filed: Jan. 13, 2015
(86) PCT No.: PCT/AU2015/050011

§ 371 Date: Jul. 13, 2016

(30) Foreign Application Priority Data
Jan. 13, 2014 (AU) 2014900098

(51) Int. Cl. H02J 3/46; H02J 3/16; H02J 13/00; H02S 50/00; H02S 40/32; H02J 3/38; H02J 3/14

(52) U.S. Cl. CPC H02J 3/46; H02J 3/382; H02J 3/16; H02J 3/14; H02S 50/00; H02S 40/32; H02J 13/00

(57) ABSTRACT

This invention relates in general to a device for isolating, controlling, limiting and supporting the power exported from the renewable energy source to the utility grid. The device comprising: a means for monitoring the direction of flow of power within the renewable energy source; a means for isolating the flow of power from the renewable energy source to the mains power supply, and wherein when a reverse power flow above agreed feed in or at least zero feed in or limited feed in is sensed by the means for monitoring between the renewable energy source to the mains power supply, the monitoring means signals the isolating means to open circuit the system and/or control/limit output of the system.

### FIELD OF THE INVENTION

This invention relates in general to renewable energy generation within a utility grid. In particular, the present invention relates to a device for isolating, controlling and limiting the power exported from the renewable energy source to the utility grid. In the present invention the device has the ability to limit or have zero reverse power flow or feed in power from the renewable energy system to the utility grid.

### BACKGROUND OF THE INVENTION

It should be noted that reference to the prior art herein is not to be taken as an acknowledgement that such prior art constitutes common general knowledge in the art.

Electricity or power is an essential part of modern life. In residences, in businesses, in institutions and in other locations, consumers use electricity in a variety of ways. Utilities deliver power generated by power plants through a network of transmission and distribution lines. This network is hereinafter referred to as the “power transmission and distribution grid,” “the electric grid,” “the grid,” “the utility grid,” “mains power”, or “power grid.”

Recently, along with the growing awareness of the global warming and other environmental problems, the human society is placing great hopes on the so-called new energies. In addition to their environmental aspects, the new energies present such advantages as low transmission loss and security of power supply because their energy production can be distributed at or close to the power consumers. Traditional energy generation from coal results in greenhouse gas emissions that are rapidly being mandated for reduction. Emerging alternative energy technologies such as wind and solar provide viable options for energy generation.

Renewable energy is a practical and environmentally conscious alternative to traditional utility production. One of the more desirable renewable sources is solar power. Solar equipment consumes no fossil fuels and generates no air pollutants. The use of solar power is generally regarded as environmentally safe. Utilities in most countries are required (or voluntarily do so) for public policy reasons to credit or actually buy excess power generated by a solar generating system from a consumer. In addition to these benefits, solar systems can provide customers with significant cost savings in the long run. As an incentive to install solar systems, government entities may provide rebates or tax deductions to customers who purchase and install solar systems.

Renewable energy systems have gained popularity to resolve at least partially the peak-demand issue of the power grid. For example, a solar power system may convert generated DC electricity from solar panels into AC electricity and be used to power electrical appliances. The generated DC power is also converted to AC power by an inverter so that power grid companies may purchase AC power produced.

At present, feed-in regulations or tariffs for renewable energy exist in over 40 countries, states or provinces internationally, all involving the payment of a premium for the electricity fed into the grid from a variety of renewable energy sources. These feed in tariffs (FiT) are typically applied in two forms. A first form is a gross FiT—whereby all electricity generated from a renewable source is purchased from the generator at a generous price, with the generator buying-back any electricity they need to use from the grid. The second form of FiT is a net FiT—whereby only unused or surplus electricity is purchased from the generator.

With the recent changes to the feed in tariffs it has become more important to the user and those who install a system need to be cognizant of how they are utilising the energy their solar systems produce. With these changes it is evident that self-consumption of solar power will become the new norm, and exporting solar power to the grid will become less attractive for system owners.

Typically the power from a solar PV system is automatically directed to household use first; if/when it is not consumed then and there, it automatically passes through an electricity meter and onto the grid. Therefore, when a household opts to ‘self-consume’ their solar power, this means that they time their power usage to coincide with generation—i.e., when the sun is shining.

While the change in subsidy structure to a solar feed-in tariff that is below the retail cost of electricity will mean that solar PV systems will provide the most benefit to those who can use their solar power as it is being produced—i.e. those who can use electricity during the day when the sun is shining, either by scheduling their appliances to run or by being physically present in order to use them. This could be pensioners, people who work from home, or stay-at-home parents. On such a low rate, without affordable storage for the solar energy, exporting power to the grid is not the most efficient way to use it. Likewise for those who are not able to be present during the peak production of solar energy (during sunshine hours) some other way of using or preventing the feed in to the grid is required.

Clearly it would be advantageous if a device for isolating and controlling the power exported from the renewable energy source to the utility grid could be devised that helped to at least ameliorate some of the shortcomings described above. In particular, it would be beneficial if a device which has the ability to ‘self-consume’ or have zero reverse power flow or feed in power from the renewable energy system to the utility grid, or to at least provide a useful alternative.

### SUMMARY OF THE INVENTION

In accordance with a first aspect, the present invention provides a device for isolating, monitoring and limiting the power exported from a renewable energy source or system to a mains power supply, the device comprising: a means for monitoring the direction of flow of power within the renewable energy source; a means for isolating the flow of power from the renewable energy source to the mains power supply; and wherein when a reverse power flow is sensed by the means for monitoring between the renewable energy source to the mains power supply, the monitoring means signals the isolating means to either reduce the output of generation to prevent or limit excess power or to open circuit the system.

Preferably, the means for monitoring the direction of flow of power and the means for isolating the flow of power from the renewable energy source to the mains power supply may be located within a common junction box adjacent to a mains switch. Alternatively, the means for monitoring the direction of flow of power and the means for isolating the flow of power from the renewable energy source to the mains power supply may be located in separate junction boxes and connected for communication either by a wired connection or a wireless connection.

Preferably, the means for monitoring the direction of flow of power may be a bi-directional voltage and/or current sensing device which sense the load on the mains power supply. Alternatively, the current sensing device may be a whole current measuring device. Further alternatively, the current sensing device may be a current transformer which uses a primary conductor as the primary winding and a secondary coil that is wired around a toroidal core that is positioned around a main conductor to measure the current.

Preferably, the voltage sensing device may be a voltage transformer or a potential transformer such as an instrument transformer. Preferably, the means for isolating the flow of power from the renewable energy source to the mains power supply may be an electrically operated switch such as a relay. The relay may further comprise a variable control means to set a value of power which will close the relay to isolate the renewable energy source from the mains power supply. The relay may further comprise a variable control means to set a value of power to close the relay to allow the flow of power from the renewable energy source to the mains power supply. The relay may further comprise a variable control means to close the relay and/or increase the power output to allow the flow of power from the renewable energy source to the mains power supply when power flow is in a forward direction.

Preferably, the device may be connected to a single phase system or a multiphase or polyphase system. The device may be designed to continuously measure and monitor both forward and reverse direction of power flow at a set point in the mains power supply.

Preferably, the renewable energy source may be any one or more of the following: (i) a solar energy source comprising at least one photovoltaic panel; (ii) a wind energy source comprising at least one wind turbine; or (iii) a hydro energy source comprising a water source using the gravitational force of falling or flowing water.

Preferably, the device may be connected into an existing renewable energy system at or adjacent a main switch to open circuit the renewable energy source and prevent the flow of power from the renewable energy source to the mains power supply.

Preferably, the variable control means may be an electronic circuit with a digitally set and variable electronic switch. Alternatively, the electronic circuit may comprise a programmable logic controller or microcontroller which can be programmed with the various settings required and be designed to provide the control parameters required. Further alternatively, the variable control means may be a mechanical circuit with a mechanically set and variable switch.

In accordance with a further aspect, the present invention provides a renewable energy generation load compensation system comprising: a mains power supply; a renewable energy source comprising: a first series comprising at least one renewable energy supply connected to a first inverter; at least one further series comprising at least one further renewable energy supply connected to a further inverter; and a contactor connected to each said inverter to electrically isolate and connect each said series to and from the system; a controllable switch comprising: a voltage and/or a current sensing devices to sense the load on the mains power supply; an energising means connected to each said contactor to isolate and energise each said series; and a microprocessor programmable to control the energising and isolation of each series; a domestic power supply network adapted to be connected to either the mains power supply or the renewable energy source; wherein said first series and inverter are sized and connected to export renewable energy to the mains power supply, and said further series and inverters are switched depending on the load or consumption on the mains power supply; and a device for isolating the power exported from the renewable energy source or system to the mains power supply in accordance with the previous aspect.

Preferably, the size of the first series and inverter may be determined by the requisite feed in tariff. When power is in a forward direction the controllable switch may connect said further series to compensate for the usage of load from the mains power supply. When forward power or load decreases the controllable switch may isolate said further series to prevent over generation from the renewable energy source.

Preferably, the system may further comprise any one or more of the following protection devices: (i) over voltage protection; (ii) under voltage protection; (iii) over frequency protection; (iv) under frequency protection; (v) differential frequency protection between the phases; (vi) phase failure protection; (vii) reverse power flow protection. (viii) rate of change of frequency (RoCoF); (ix) voltage vector shift (VVS); (x) output limitation; or (xi) re-active power control. Should any one of the protection devices be energised the system may isolate and protect the mains power supply.

Preferably, the system may further comprise an event logger to monitor and analyse each phase of the mains power supply.

Preferably, the controllable switch may be programmed to allow the requisite feed in tariff to be exported with all series connected to the mains power supply.

Preferably, the system may automatically disconnect from the mains power supply in order to protect the mains power supply from an islanding fault. Preferably, the system may further comprise a data network for transferring information between the controllable switch, the mains power supply, the renewable energy source, and the domestic power supply network.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

FIG. 1 is a single line drawing of the device in accordance with the present invention;

FIG. 2 is a single line block diagram of the device installed in a renewable energy system in accordance with an embodiment of the present invention;

FIG. 3 is a schematic view of the device installed in the renewable energy system of FIG. 2;

FIG. 4 is a single line block diagram of the device installed in a renewable energy system in accordance with a further embodiment of the present invention;

FIG. 5 is a schematic view of the device installed in the renewable energy system of FIG. 4;

FIG. 6 shows a block diagram a domestic installation of a renewable energy system with the device of the present invention installed; and

FIG. 7 shows the present invention used in a 3 phase system with internal CT's built into the controller in accordance with an embodiment of the present invention.

### DETAILED DESCRIPTION OF THE PREFERRED EMBODIMENTS

The following description, given by way of example only, is described in order to provide a more precise understanding of the subject matter of a preferred embodiment or embodiments.

Described embodiments relate generally to a device for isolating and monitoring the power exported from a renewable energy source or system to a mains power supply and to systems for a renewable energy generation load compensation incorporating such a device. The device in accordance with the present invention is typically used for solar photovoltaic fed grid installations for the purpose of isolating the mains supply grid from the renewable energy source and the described embodiments are particularly suited to such purposes. Embodiments are not, however only limited to such use.

Photovoltaic (PV) is a method of generating electrical power by converting solar radiation into direct current electricity using semiconductors that exhibit the photovoltaic effect. Photovoltaic power generation employs solar panels composed of a number of solar cells containing a photovoltaic material. A PV system is made up of one or more photovoltaic (PV) panels 65, 66, a DC/AC power converter or inverter 52, 53, electrical interconnections, and associated switches and contactors 50, 51. The electricity generated can be either stored, used directly (island/standalone plant), or fed into the electricity grid 15, or combined with one or many domestic renewable energy generators to feed into a small grid.

Renewable energy is energy that comes from resources which are continually replenished such as sunlight, wind, rain, tides, waves and geothermal heat. Therefore the present invention is not limited to any particular renewable energy. For example, in addition to the solar systems, wind turbines have also been employed to provide clean or renewable energy. The wind turbine generates an AC power from the kinetic energy of the wind through a system comprising a rotator, a gearbox and a generator. The AC power is rectified into a DC power and is further converted into AC power with the same frequency as the AC power from the power grid 15. Likewise, hydroelectricity is the term referring to electricity generated by hydropower; the production of electrical power through the use of the gravitational force of falling or flowing water.

The renewable energy can also extend to any type of generation system (not shown). For example, a diesel generator is the combination of a diesel engine with an electric generator (often an alternator) to generate electrical energy. This is a specific case of engine-generator. A diesel compression-ignition engine often is designed to run on fuel oil, but some types are adapted for other liquid fuels or natural gas. Typically diesel generating sets are used in places without connection to a power grid, or as emergency power-supply if the grid fails, as well as for more complex applications such as peak-lopping, grid support and export to the power grid.

The present invention is particularly useful if there are multiple/parallel generators. The use of additional solar connected in conjunction with the diesel generators can prevent the next generator from turning on. This is mainly due to the need of generators to not run below approximately 60% load.

The following description will be described with reference to solar energy and the use of photovoltaic panels however, the production of renewable energy is not limited to only such use. Likewise, isolation referred to in the following paragraphs refers to both electrical and mechanical isolation. Therefore isolation for both the mains grid 15 and the renewable energy supply 52, 53 may incorporate both mechanical and electrical isolation in order to protect both the main and the renewable energy supplies and their associated components. The mains power supply or grid supply 15 provides mains electricity in the form of general-purpose alternating-current (AC) electric power supply. Worldwide, many different mains power systems are found for the operation of household and light commercial electrical appliances and lighting. The main differences between the systems are primarily characterised by their voltage, frequency, plugs and sockets (receptacles or outlets), and earthing system (grounding). The device 10 is connected to a single phase system or a multiphase or polyphase system.

The mains power or grid supply 15 is fed via transmission lines to dwellings via a consumer meter 18. An electricity meter or energy meter 18 is a device that measures the amount of electric energy consumed by a residence or dwelling. Incorporating grid fed renewable energy generating equipment, means when a customer may be generating more electricity than required for his own use, the surplus may be exported back to the power grid 15. Customers that generate back into the “grid” usually have special equipment and safety devices to protect the grid components (as well as the customer's own) in case of faults (electrical short circuits) or maintenance of the grid (say voltage potential on a downed line going into an exporting customers facility).

Power export metering 18 provides metering which is capable of separately measuring imported and exported energy as used or required. Typically these meters 18 are a bi-directional import/export meter which can measure both how much electricity is used in the home, and how much electricity gets fed back into the grid from the solar power system 52, 53. A main switch 19 isolates the main power grid 15 from the residence or dwelling sub circuits 41. Likewise, the renewable energy switch or circuit breaker 50, 51 isolates the renewable energy source 52, 53 from the mains power supply 15 and the residence or dwelling sub circuits 41.

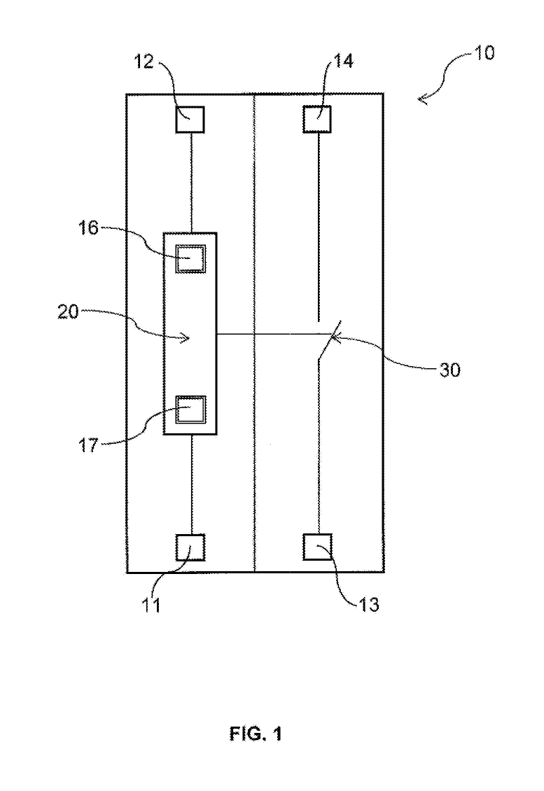

FIG. 1 illustrates a device and its connection points in accordance with an embodiment of the present invention. The device 10 consists of a sensing or monitoring component 20 and an isolator or relay 30. The monitoring component 20 provides the ability of the present device to continuously monitor and measure both forward and reverse direction of power flow at a set point in the mains power supply. The present invention has been designed in order to allow the user to self-consume all solar power produced by the renewable energy supply 52, 53 and not export solar power to the utility grid 15. However when taking into account a feed-in-tariff the solar energy which is prevented from feeding back into the grid is any value which falls within the range above the agreed feed-in-tariff. Basically only the amount of renewable energy which equals the agreed feed-in-tariff value will be fed back into the grid. Any amount of renewable energy generated above the feed-in-tariff will be self-consumed or output limited and not fed back into the grid. Likewise if there is no agreed feed-in-tariff then all renewable energy generated will be self-consumed. Therefore the present invention has been designed to open the export relay at or close to zero energy generated by the renewable energy system or at a value just above the feed-in-tariff if applicable. Due to the flexibility in design of the present invention the value upon which the export relay or zero export relay will open can be limited at a set export value. For example the export value may be set at 2 kW and the export relay will open circuit the relay to isolate the renewable energy source from the mains.

These changes have come about due to the substantial reductions in the feed in tariff (Fit) along with the significant reduction in the cost of installing renewable energy systems. Policy provided by the network providers is also dictating changes to the systems. The present invention is designed to both self-consume all renewable energy produced but also protect the network from the negative impact of uncontrolled renewable energy that is being fed into the grid.

The device 10 consists of a line side circuit connection 11, a load side circuit connection 12, a line side of the circuit to be controlled 13 and a load side of the circuit to be controlled 14. All of the above are standard wiring connections and connectors or the like. The above show connections as shown in FIG. 1, however wiring can be used on either side, either line or load and is therefore not restricted to only the illustrated version.

The monitoring means 20 consists of a bi-directional voltage and/or current sensing device which sense the load on the mains power supply 15. The current or voltage sensing device 20 can be located within the device 10 or can be externally located. Current sensing CT's can be mounted internally with the relay 30 in the device 10. Likewise when retrofitting the device 10 to an established system the CT's can be mounted externally in any suitable location. For example, the relay 30 can be mounted anywhere there is room, then simply clamp (split core) the CT's 20 in any suitable location (before or after the customer Main Switch 19). For best results when utilizing internal CT's 20 the relay 30 should be wired in directly after the main switch 19 before any other sub circuits.

Typically this may comprise a current sensing device 20 such as a whole current measuring device. This may include a single phase meter used to measure AC mains current in which the whole current to be measured flows directly through the meter—as opposed to a current transformer type measuring systems where the current is converted to an indirect variable which is measured by a meter which is not directly measuring the actual current. For example a current transformer which uses a primary conductor as the primary winding and a secondary coil that is wired around a toroidal core that is positioned around a main conductor to measure the current. The number of turns of the secondary coil determines the current reduction ratio; the ratio is chosen to reduce normal operating current down to a level that protection equipment can use to make measurements. If for example the sensing device is a voltage sensing device 20 then the device may comprise a voltage transformer or a potential transformer such as an instrument transformer.

The means for isolating the flow of power from the renewable energy source 52, 53 to the mains power supply 15 consists of a relay or contactor 30. A relay 30 is basically an electrically operated switch. Many relays use an electromagnet to operate a switching mechanism mechanically, but other operating principles are also used. Relays are used where it is necessary to control a circuit by a low-power signal (with complete electrical isolation between control and controlled circuits), or where several circuits must be controlled by one signal. Another type of electrically operated switch which may be used in the present invention and is also the type of relay 30 that can handle the high power required to directly control a loads is a contactor 30. The relay 30 can be a single pole relay or multiple pole relay.

Another option which can be used in the present invention is a solid-state relay which control power circuits with no moving parts, instead using a semiconductor device to perform switching. As would be appreciated by a skilled person a number of options exist for the isolation of the renewable energy source 52, 53 from the mains power supply 15. By way of another example the relay 30 may comprise a set of dry contacts rated at a predetermined current in order to open circuit the export power from the renewable energy source 52, 53 to the mains power supply 15. Typically a dry contact is used when switching very low level signals, and the contact materials may be gold-plated contacts.

The monitoring means 20 also includes a number of adjustable settings or timers 16, 17 which can be utilised to set a value of power which will open the relay 30 to isolate the renewable energy source 52, 53 from the mains power supply 15 or to set a time delay for opening or closing the relay 30 to isolate or connect the renewable energy source 52, 53 to the mains power supply 15. These may be a mechanically adjustable setting or an advanced electronic or software setting. That is the setting may be preset and not changeable to prevent tampering or a variable control which allows adjustment of the closing or opening of the relay 30. This also means the turn off or disconnect value can be set to zero for zero export or limited at a set export value such as 2 kW which may be a value that a network might allow as an export regardless of the size of the system connected. For example the variable control means or adjustable settings comprise an electronic circuit with a digitally set and variable electronic switch. This may include a programmable logic controller or microcontroller which can be programmed with the various settings required and be designed to provide the control parameters required to adjust to suit the system.

By way of a further example, a timer or time switches may be free-standing or incorporated into appliances and machines. Their operating mechanism may be mechanical (typically clockwork), electromechanical, or purely electronic (counting cycles of an electronic oscillator). Timing functionality can be provided by software, typically in a computer; the program is often called a “timer”. In use, variable adjustment 17 is a time delay setting for closing the relay 30. Variable adjustment 16 consists of two variable controls. A first control value is used to set the value of power flow which will close the isolation relay 30. Its purpose is to prevent the renewable power source 52, 53 from energising when power flow is greater than the load placed on the system by the sub circuit loads 41. This prevents any on/off cycling of the controlled renewable energy generation 53 and is set to suit the output of the controlled renewable energy generation 53 and also delays the closing of the contacts in the relay 30 until power flow is in the forward direction (flowing from the utility grid 15 to the renewable energy source 53) and above the set value.

Optionally, a second set of monitoring means (not shown) can be placed on the renewable energy generation side which will allow the relay 30 to calculate the value of the load on the system. If the relay 30 is limiting the output of the inverter 52, 53 it can steadily hold this value rather than chase the fluctuating value at the main switch 19.

Basically the system prevents energy from flowing from the renewable energy source 53 to the utility grid 15, ie from going into export straight away after the relay has been closed. The second control value is the preset off value or the value and direction of power flow before the isolation relay 30 is opened and therefore isolates the renewable energy source 53 from the utility grid 15. The purpose of the second control value is to allow the off value to be higher than unity (zero) or even allow power flow to be a set value in the reverse direction (export). These variable controls could simply be a control dial knob which allows for manual setting or could be a computer programmable software setting.

The adjustable setting 17 is a time delay setting which delays the closing of the relay 30 and is variable to suit the required time delay. This also means when multiple devices are incorporated the closing of these devices can be staggered which helps prevent exporting on closing. This is also important when a load is supported which is not a constant load on the system—ie the load varies. This time delay setting 17 works in sequence once power flow is back in the forward direction and above the value set by variable adjustment 16. For example, with a time delay set at “O” contacts at relay 30 will close when power is flowing in the forward direction from the utility grid 15 to the renewable energy source 53 or the value which is set by the first control value of variable setting 16. Likewise, with the time delay 17 set to a certain time value, the relay 30 will close after the sequence of the preset value of 16 is satisfied, time delay starts timing out to the set time value, after time out, the relay 30 will close allowing power to flow from the PV 52, 53 to the load.

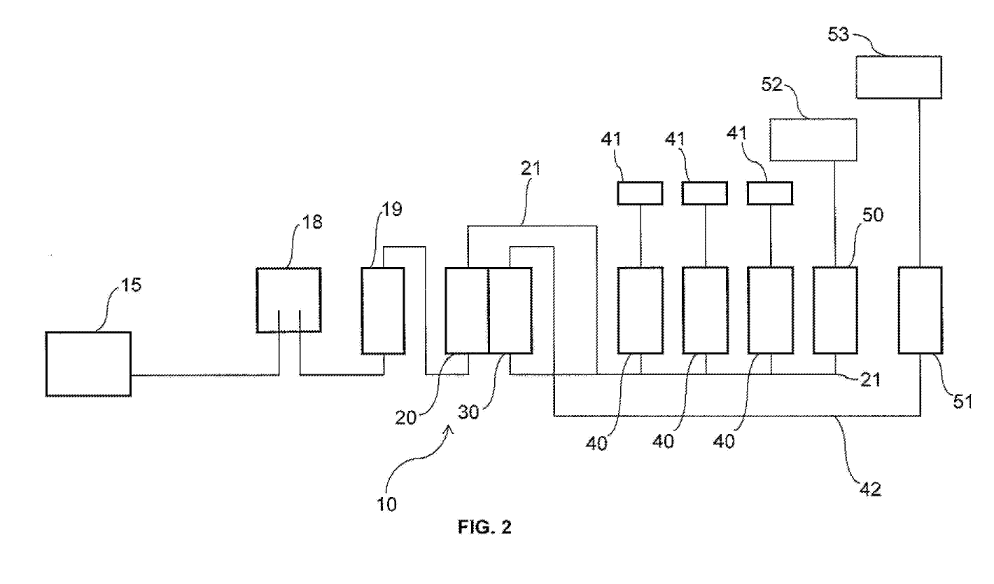

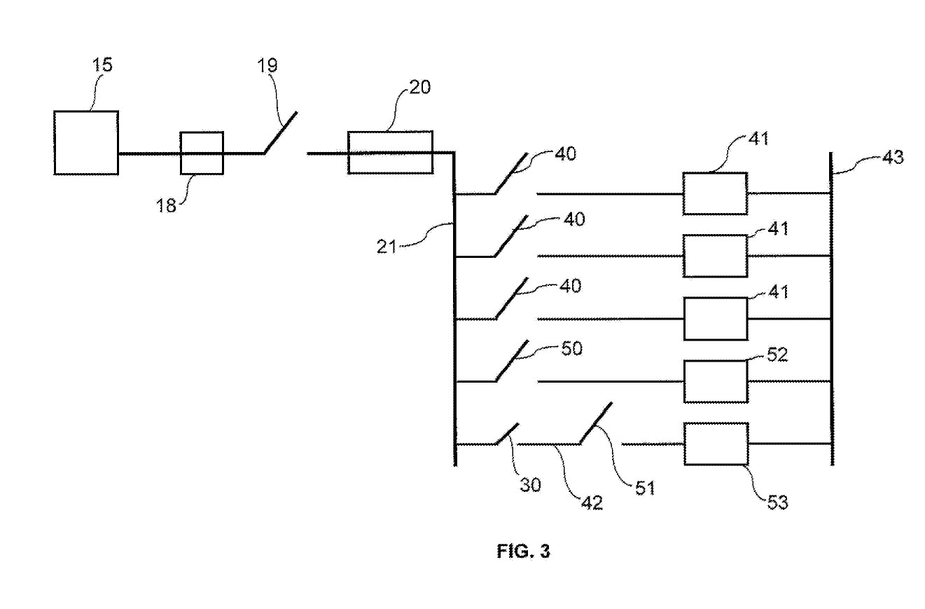

FIGS. 2 and 3 show a first embodiment of the present invention with the device 10 installed in a single phase mains supply 15 for a renewable energy system. In this embodiment the controllable renewable energy source 53 is controlled by the device 10 via a common feed/bus 42. A circuit breaker 51 is placed in the common feed/bus 42 to open circuit the renewable energy source 53 in case of faults (electrical short circuits) or maintenance of the renewable energy source 53. When the relay 30 is closed energy can flow from the renewable energy source 53 into the utility grid 15 or vice versa. Likewise the renewable energy source 53 can feed the sub circuit loads 41 via common feed bus 21 and circuit breakers 40. Also the a renewable energy source 52 which is not controlled by the device 10 can also feed the sub circuit loads 41 via circuit breaker 50 and circuit breakers 40. Power flows from the utility grid 15 through the retail revenue meter 18 and through the customer main switch 19 and then through the sensing side 20 of the device 10. Mains power 15 is then fed via common electrical feed/bus 21 to the sub circuit loads 41.

In order to prevent the flow of energy from the controlled renewable energy source 53 back into the grid the relay 30 is opened and power from the renewable energy source 30 will not be fed back into the utility grid 15. The power sensor 20 or in this case a whole current sensing meter 20 will sense when power is flowing from the controlled renewable energy source 53 to the utility grid 15 and subsequently after a preset time delay will limit the output of power as needed and/or open relay 30. In this operation the controlled renewable energy source 53 is said to be self-consumed or utilised as a zero export renewable energy source 53.

FIG. 3 is a single line drawing of the renewable energy system of FIG. 2. In this embodiment the isolation relay 30 is connected to open the controlled renewable energy source 53 via the connection or common feed/bus 42 and circuit breaker 51. The common neutral 43 is connected on the opposite side from the power feed of the loads 41 and the renewable energy sources 52, 53. The neutral 43 provides a low impedance path to earth. As shown in both FIGS. 2 and 3 the renewable energy source 53 is controlled by the device 10 and the renewable energy source 52 is not controlled by the device 10. This enables the renewable energy source 52 to supply the FiT for the system which is feed back into the utility grid 15. The controlled renewable energy source 53 ensures any power delivered by the source 53 will not be fed back into the utility grid 15 by the control and isolation of the device 10.

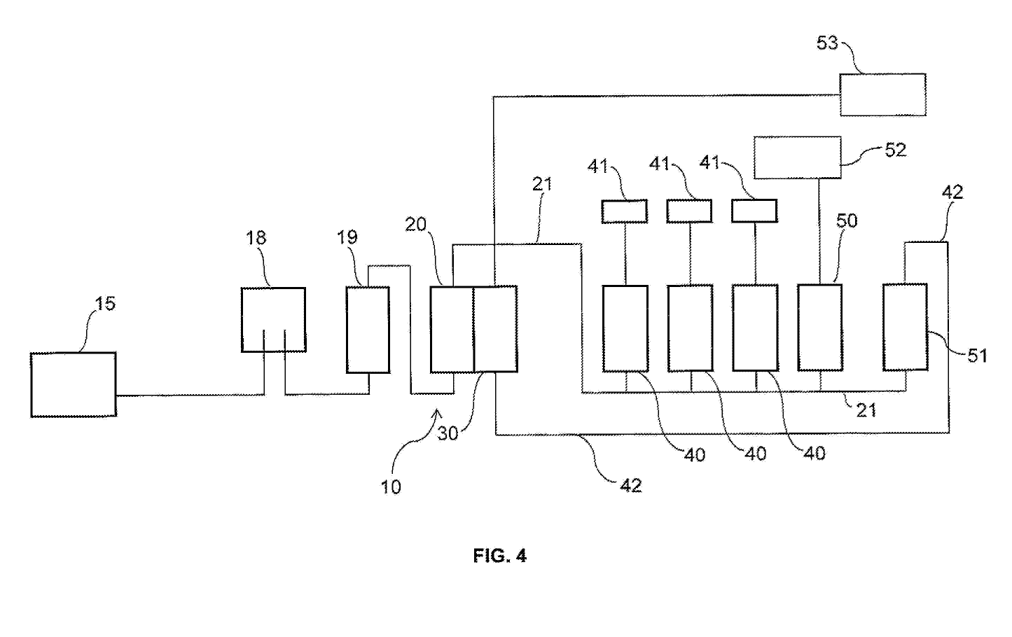

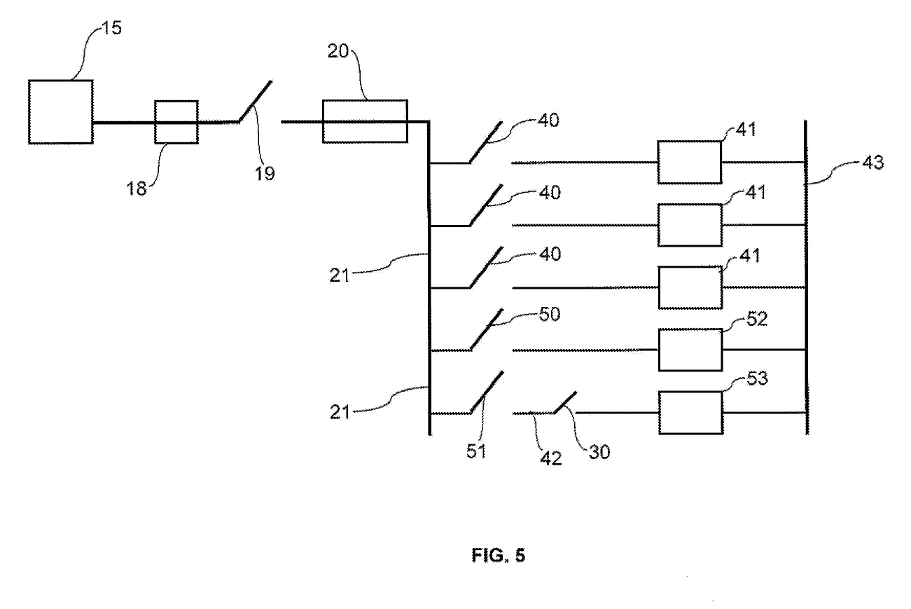

FIGS. 4 and 5 are substantially the same as FIGS. 2 and 3 and like components are marked accordingly. The difference between the device 10 of FIGS. 4 and 5, and the device 10 of FIGS. 2 and 3 is the positioning of the isolation relay 30. In FIGS. 4 and 5 the isolation relay 30 is positioned beside the controlled renewable energy source 53 and is connected via feed/bus 42 to circuit breaker 51 and the common feed/bus 21. In FIGS. 2 and 3 the control and isolation relay 30 is directly connected to the common feed/bus 21 with the circuit breaker 51 being connected beside the controlled renewable energy source 53.

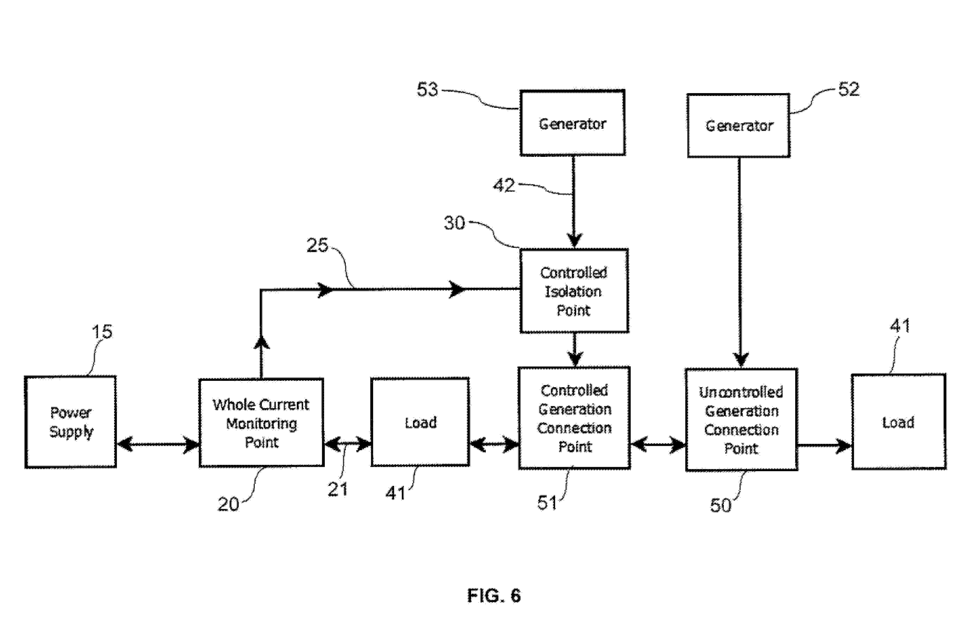

FIG. 6 illustrates a block diagram of a domestic installation of a renewable energy system with the device 10 of the present invention installed to control a renewable energy source 53. The mains supply 15 is connected to the sensing device 20, which in this case is a whole current sensor 20. The current sensor 20 detects the direction and/or value of power flowing from the controlled renewable energy source 53 to the mains 15. When this condition is sensed a control signal is sent via communication cable 25 to the isolation relay 30. The isolation relay 30 will then open and prevent the flow of renewable energy from the controlled renewable energy source 53 via the controlled generation connection point or circuit breaker 51 to the mains 15. The system also comprises an uncontrolled renewable energy source 52 which can supply the power to the loads 41 and mains 15.

The device 10 may be installed in a system as a single component with both the sensing device 20 and control relay 30 mounted side-by-side within an equipment rack. However, the present invention is not limited to a single component and all components may be separate and mounted in different locations. For example, the external CT's which can be beneficial for a retrofit in particular when space is limited. The device 10 also allows the output control of both power and reactive power through either/or digital, analog, binary, Modbus etc. Were Modbus is a serial communication protocol developed for use with programmable logic controllers (PLCs). In simple terms, it is a method used for transmitting information over serial lines between electronic devices.

Typically the device 10 is located adjacent the user's main switch 19 and wired together or connected via wireless communications. In some example installations the sensing device 20 and the isolation relay 30 may be mounted separately and connected either via a wireless connection or a wired connection. By way of example only the present device 10 is mounted on a din rail in the equipment rack (not shown). A DIN rail is a metal rail of a standard type widely used for mounting circuit breakers and industrial control equipment inside equipment racks. The Din rails are typically made from cold rolled carbon steel sheet with a zinc-plated and chromated bright surface finish. An equipment rack is a standardised frame or enclosure for mounting multiple equipment modules.

In use the device 10 can be incorporated into a load compensation system. In order to provide the compensation for the load or sub circuits 41 on the mains power supply 15 incorporates a load compensation device and associated circuitry. A mains power supply 15 provides mains electricity in the form of general-purpose alternating-current (AC) electric power supply. The mains power or grid supply 15 is fed via transmission lines to dwellings and a consumer meter 18. Incorporating grid fed renewable energy 53 generating equipment, and means when a customer is generating more electricity than required for his own use, the surplus may be exported back to the power grid 15. In order to avoid the surplus renewable energy or at least limit the exported energy being fed back into the mains grid 15 the device 10 has been designed to control and isolate the renewable energy source.

A main switch 19 isolates the main power grid 15 from the residence or dwelling sub circuits 41. Likewise, the renewable energy main switch 51 isolates the renewable energy source 53 from the mains power supply 15 and the residence or dwelling sub circuits 41. The renewable energy load compensation device is designed to continuously measure and monitor both forward and reverse direction of power flow in the mains power supply 15. When power is in the forward direction (consumption) the load compensation device will first connect solar string with the inverter and solar array 53 to feed the sub-circuits 41. Alternatively, if power is in the forward direction (consumption) and the system is configured for export then load compensation device will first connect one solar string with the inverter and solar array 53 designed and sized to the agreed feed in tariff to export renewable energy fed to the grid 15. The device 10 can also incorporate auxiliary switches for the purpose of switching and controlling both essential and non-essential loads. These loads can be switched to help manage peak demand and the utilisation of any surplus power ie self-consume.

The present invention may also include a data network (not shown) to monitor and control the transmission of data around the system. The present invention also allow the consumer to continuously measure, control, and monitor both forward and reverse direction of power flow in the mains power supply. With the use of a data network connecting a computer system having a computer readable program stored on the computer the renewable energy load compensation system can be automated or manually controlled by the consumer with the use of a computer.

For all of the above options the circuitry has been designed to be energised to connect. Therefore if any fault or failure in the system occurs all items are protected on de-energise. The present invention may provide a number of additional programmed protection devices such as over voltage protection, under voltage protection, over frequency protection, under frequency protection, differential frequency protection between the phases, phase failure protection and reverse power flow protection. While the above have been described the present invention is not limited to only the rate of change of frequency (islanding detection method for decentralized generation units) and voltage Vector Shift (VVS) methods could also be used for Loss-Of-Mains (LOM) detection.

All of the above are programmable into the load protection device in order to further protect and isolate the system should any one of the faults occur. This also applies to all mechanical isolation devices within the renewable energy load compensation systems which are designed to be energised to connect and therefore on failure or faults will be de-energised to protect both the mains power supply and the renewable energy power supply and associated components.

It is also envisaged that the system may also comprise a data logger to log and graph each phase over a predetermined time scale. A data logger or data recorder is an electronic device that records data over time or in relation to location either with a built in instrument or sensor or via external instruments and sensors. The data logger can be based on a digital processor (or computer). The data logger may be a small, battery powered, portable, and equipped with a microprocessor, internal memory for data storage, and sensors. Also, the internal memory could be a removable plug in USB memory stick which would allow the operator to save room on the data logger circuit board.

The data logger may interface with a personal computer and utilize software to activate the data logger and view and analyse the collected data. Likewise the data logger may have a local interface device (keypad, LCD) and can be used as a stand-alone device. The data logger can also incorporate the graphing and logging for real-time or historical logging.

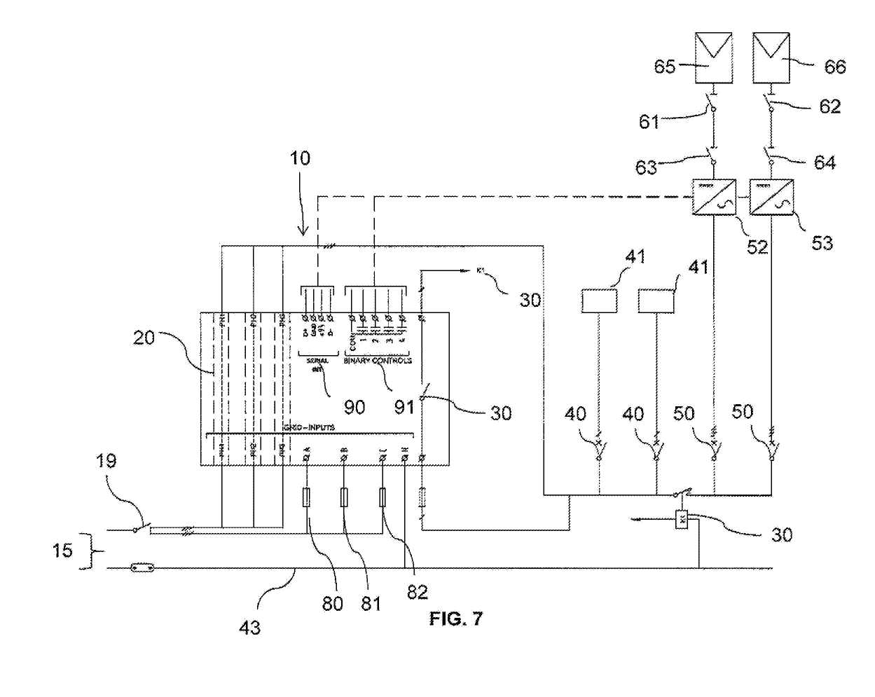

By way of a further example FIG. 7 is provided to show the present invention used in a 3 phase system with internal CT's 20 built into the controller or device 10. The actual sensing wire passes directly through the device 10. The three phases A, B and C and represented as items 80, 81 and 82 with a neutral wire 43. The renewable energy generation is supplied by PV's 65, 66 with DC supplied via rooftop isolators 61, 62 and DC isolators 63, 64. The DC output is fed to the inverters 52, 53 and to the AC output of the inverters 52, 53 is fed via circuit breakers 40, 50 to the loads 41.

The relay 30 is utilised when closed to allow the renewable energy from the PV's 65, 66 to feed the loads 41. A mains power supply 15 provides mains electricity in the form of general-purpose alternating-current (AC) electric power supply. The mains power or grid supply 15 is fed via transmission lines to dwellings and a consumer meter (not shown). Incorporating grid fed renewable energy 52, 53 generating equipment, which means when a customer is generating more electricity than required for his own use, the surplus may be exported back to the power grid 15. In order to avoid the surplus renewable energy or at least limit the exported energy being fed back into the mains grid 15 the device 10 has been designed to control and isolate or at least limit the exported energy from the renewable energy source.

The device 10 consists of a sensing or monitoring component 20 in this case three internally installed CT's 20 and an isolator or relay 30. The monitoring component 20 provides the ability of the present device to continuously monitor and measure both forward and reverse direction of power flow at a set point in the mains power supply. The present invention has been designed in order to allow the user to self-consume all solar power produced by the renewable energy supply 52, 53 and not export solar power to the utility grid 15. The device 10 also comprises control outputs for serial output 90 and for binary control outputs 91. In FIG. 7 the binary outputs 91 are used to control the inverters 52, 53. This connection can be either one way or two way communication between the device 10 and the inverters 52, 53. The serial or binary outputs 90, 91 are also utilized to provide outputs such as limitation, data, generation, active power, reactive power. The switching of the binary outputs 91 is generally through programming carried out during the setup of the device 10 and can be used for any bit binary switching. For example a 4 bit binary would give up to 16 switching points or whole switching which could ramp up 1, 2, 3, 4 and then down 4, 3, 2, 1. Likewise 6 bit binary would give up to 64 switching points. FIG. 7 also illustrates the mechanical isolation which is required for such systems

The present invention is a self-contained device 10 which can be computer programmed either on-site or remotely via a network. This includes the programming of the timers, the system, the feed in tariff allowance and any remote switching of loads and the control, limited export and consumption of the system.

While the present invention has been largely described in relation to allow the user to self-consume or at least limit the amount of solar power produced by the renewable energy supply and not export or at least limit the export of solar power to the utility grid. The system also provides for the continued support and use of renewable energy under normal use conditions and/or when returning from self-consume mode to normal operation of the system. For example, as described above the binary outputs of the system can be used to ramp down the system to either limit or stop export to the grid or can ramp up after the system returns from self-consume or limit operation.

### ADVANTAGES

By using renewable energy systems to power your home or business you are reducing greenhouse gas emissions and your electricity bills. The present invention has been designed in order to allow the user to self-consume all solar power produced by the renewable energy supply and not export or at least limit the export of solar power to the utility grid. The present invention allows the user to control the amount of renewable energy which is utilized by the system while also controlling and limiting the amount of energy fed back to the grid. These changes have come about due to the substantial reductions in the feed in tariff (Fit) along with the significant reduction in the cost of installing renewable energy systems.

The present invention provides the added advantage of being able to allow additional solar generation in an installation to be used for the purpose of compensating the load from the grid only. Furthermore the present invention monitors and protects the grid by way of isolation from unwanted exporting of over generated renewable energy. The present invention manages and limits the export of power to the mains supply by way of isolation.

Likewise both the renewable energy source and componentry and the mains power componentry are energised to connect therefore any fault or failure in the system all items are protected on de-energise mechanically or electronically through the power output limitation.

The present invention provides a consumer with the ability to manage the output of their renewable energy supply using the AC side and the load on the mains supply.

### VARIATIONS

It will be realized that the foregoing has been given by way of illustrative example only and that all other modifications and variations as would be apparent to persons skilled in the art are deemed to fall within the broad scope and ambit of the invention as herein set forth.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

1-30. (canceled)

31. A device for limiting or preventing the export of power from a user's renewable energy source or system to a mains power supply, the device comprising:
a means for monitoring the direction of flow of power within the renewable energy source;
a means for isolating the flow of power from the renewable energy source to the mains power supply;
wherein when a reverse power flow is sensed by the means for monitoring between the renewable energy source and the mains power supply, the monitoring means signals the isolating means to limit or prevent export of the user's renewable energy to the mains power supply.

32. A device according to claim 31, wherein the means for monitoring the direction of flow of power and the means for isolating the flow of power from the renewable energy source to the mains power supply are located within a common junction box adjacent to a mains switch.

33. A device according to claim 31, wherein the means for monitoring the direction of flow of power and the means for isolating the flow of power from the renewable energy source to the mains power supply are located in separate junction boxes and connected for communication either by a wired connection or a wireless connection.

34. A device according to claim 31, wherein the means for monitoring the direction of flow of power is a bi-directional voltage and/or current sensing device which senses the load on the mains power supply.

35. A device according to claim 34, wherein the current sensing device is a whole current measuring device.

36. A device according to claim 34, wherein the current sensing device is a current transformer which uses a primary conductor as the primary winding and a secondary coil that is wired around a toroidal core that is positioned around a main conductor to measure the current.

37. A device according to claim 34, wherein the voltage sensing device is a voltage transformer or a potential transformer such as an instrument transformer.

38. A device according to claim 31, wherein the means for isolating the flow of power from the renewable energy source to the mains power supply is an electrically operated switch such as a relay.

39. A device according to claim 38, wherein the relay further comprises a variable control means to set a value of power which will open the relay to isolate the renewable energy source from the mains power supply.

40. A device according to claim 38, wherein the relay further comprises a variable control means to set a time delay for closing the relay to connect the renewable energy source to the mains power supply.

41. A device according to claim 38, wherein the relay further comprises a variable control means to set a value of power to close the relay to allow the flow of power from the renewable energy source to the mains power supply.

42. A device according to claim 38, wherein the relay further comprises a variable control means to close the relay and/or increase the power output to allow the flow of power from the renewable energy source to the mains power supply when power flow is in a forward direction.

43. A device according to claim 31, wherein the device is connected to a single phase system or a multiphase or polyphase system.

44. A device according to claim 31, wherein the device is designed to continuously measure and monitor both forward and reverse direction of power flow at a set point in the mains power supply.

45. A device according to claim 31, wherein the renewable energy source is any one or more of the following:
(i) a solar energy source comprising at least one photovoltaic panel;
(ii) a wind energy source comprising at least one wind turbine;
(iii) a hydro energy source comprising a water source using the gravitational force of falling or flowing water; or
(iv) a diesel generator.

46. A device according to claim 31, wherein the device is connected into an existing renewable energy system at or adjacent a main switch to open circuit the renewable energy source and prevent the flow of power from the renewable energy source to the mains power supply.

47. A device according to claim 39, wherein variable control means is an electronic circuit with a digitally set and variable electronic switch.

48. A device according to claim 47, wherein the electronic circuit comprises a programmable logic controller or microcontroller which can be programmed with the various settings required and be designed to provide the control parameters required.

49. A device according to claim 39, wherein the variable control means is a mechanical circuit with a mechanically set and variable switch.

50. A device according to claim 31 including a means for measuring the value of flow of power from the renewable energy source to the mains power supply.

51. A renewable energy generation load compensation system comprising:
a mains power supply;
a renewable energy source comprising:
a first series comprising at least one renewable energy supply connected to a first inverter;
at least one further series comprising at least one further renewable energy supply connected to a further inverter; and
a contactor connected to each said inverter to electrically isolate and connect each said series to and from the system;
a controllable switch comprising:
a voltage and/or a current sensing devices to sense the load on the mains power supply;
an energizing means connected to each said contactor to isolate and energize each said series; and
a microprocessor programmable to control the energizing and isolation of each series
a domestic power supply network adapted to be connected to either the mains power supply or the renewable energy source;
wherein said first series and inverter are sized and connected to export renewable energy to the mains power supply, and said further series and inverters are switched depending on the load or consumption on the mains power supply; and
a device for isolating the power exported from the renewable energy source or system to the mains power supply in accordance with claim 31.

52. The system according to claim 51, wherein the size of the first series and inverter are determined by the requisite feed in tariff.

53. The system according to claim 51, wherein when power is in a forward direction the controllable switch will connect said further series to compensate for the usage of load from the mains power supply.

54. The system according to claim 51, wherein when forward power or load decreases the controllable switch will isolate said further series to prevent over generation from the renewable energy source.

55. The system according to claim 51, wherein the system further comprises any one or more of the following protection devices:
(i) over voltage protection;
(ii) under voltage protection;
(iii) over frequency protection;
(iv) under frequency protection;
(v) differential frequency protection between the phases;
(vi) phase failure protection;
(vii) reverse power flow protection;
(viii) rate of change of frequency (RoCoF);
(ix) voltage vector shift (VVS);
(x) output limitation; or
(xi) re-active power control.

56. The system according to claim 55, wherein should any one of the protection devices be energized the system will isolate and protect the mains power supply.

57. The system according to claim 51, wherein the system further comprises an event logger to monitor and analyze each phase of the mains power supply.

58. The system according to claim 51, wherein the controllable switch is programmed to allow the requisite feed in tariff to be exported with all series connected to the mains power supply.

59. The system according to claim 51, wherein the system will automatically disconnect from the mains power supply in order to protect the mains power supply from an islanding fault.

60. The system according to claim 51, further comprising a data network for transferring information between the controllable switch, the mains power supply, the renewable energy source, and the domestic power supply network.
